(19) United States
(12) Patent Application Publication
(10) Pub. No.: US 2015/0248072 A1
(43) Pub. Date: Sep. 3, 2015

(54) TONER

(71) Applicant: CANON KABUSHIKI KAISHA, Tokyo (JP)

(72) Inventors: Yasushi Katsuta, Susono-shi (JP); Katsuyuki Nonaka, Mishima-shi (JP); Taiji Katsura, Suntou-gun (JP); Shintaro Kawaguchi, Yokohama-shi (JP); Shintaro Noji, Mishima-shi (JP)

(21) Appl. No.: 14/630,636

(22) Filed: Feb. 24, 2015

(30) Foreign Application Priority Data
Feb. 28, 2014 (JP) 2014-038036

(51) Int. Cl. G03G 9/087

(52) U.S. Cl. CPC G03G 9/08755; G03G 9/08711

(57) ABSTRACT

A toner comprising a toner particle containing a resin, wherein the resin contains a styrene acrylic resin and a polyester resin A, the content ratio of the styrene acrylic resin is 50.0 mass % to 99.0 mass % based on the resin, the content ratio of the polyester resin A is 1.0 mass % to 35.0 mass % based on the resin, and the polyester resin A contains 0.10 mol % to 30.0 mol % of an isosorbide unit based on a total number of monomer units constituting the polyester resin A.

### BACKGROUND OF THE INVENTION

1. Field of the Invention

The present invention relates to a toner used in an electrophotography method, electrostatic recording method, magnetic recording method or toner jet printing method.

2. Description of the Related Art

Conventionally in image-forming methods such as electrophotography or electrostatic printing, charged toner particles develop an electrostatic latent image on a photosensitive drum by electrostatic force corresponding to a potential difference on the drum. At this time, toner charge is specifically generated by friction between toner and other toner, between toner and a carrier, or between toner and a regulating blade. Consequently, it is essential to control the charging performance of the toner.

On the other hand, LED and laser printers have come to constitute the mainstream of printer devices that have recently appeared on the market, and the technology used in these printers is moving in the direction of higher resolution, with printers previously having resolution of 300 dpi or 400 dpi now demonstrating resolution of 600 dpi or 1200 dpi. Thus, developing methods are correspondingly being required to demonstrate higher definition accompanying these advances. Consequently, toner is required that is capable of maintaining favorable charging performance. Studies are being actively conducted to improve toner charging performance in response to these circumstances. Although the triboelectric charging properties of the binder resin per se can also be used to control toner charging performance, in general, a charge control agent is added that imparts charging performance.

Examples of conventional charge control agents include metallic complex salts of mono azo dyes, nitrohumic acid and salts thereof, metal compounds of salicylic acid, alkyl salicylic acids, dialkyl salicylic acids, naphthoic acid and dicarboxylic acids, boron compounds, urea compounds, silicon compounds, calixarene, sulfonated copper phthalocyanine pigments and chlorinated paraffin.

Among these charge control agents containing dyes and pigments, metal compounds of salicylic acid, alkyl salicylic acids, dialkyl salicylic acids, naphthoic acid, dicarboxylic acids and the like are able to impart adequate charging performance to toner. Moreover, since the rise of the charge is also favorable, they are capable of demonstrating high performance as charge control agents.

However, nearly all of these charge control agents undergo thermal decomposition of the charge control agent per se or decomposition due to the effects of other materials during toner production, whereby a decrease in charging performance is caused. In addition, since they also tend to easily absorb moisture in high-humidity environments, toner charging performance tends to decrease thereby preventing the toner from functioning adequately.

Moreover, in order for these charge control agents added to toner to demonstrate adequate triboelectric charging performance, they must be present in the optimum amount near the surface of toner particles. If the amount of charge control agent present near the toner surface is low, toner charge quantity decreases or the charge quantity distribution of the toner easily becomes broad. In addition, if the amount of charge control agent near the surface of toner particles is excessively high, image density decreases due to an excessively high charge quantity of the toner in low-humidity environments. In this manner, there is an optimum value for the amount of charge control agent present near the surface of toner particles. However, it is currently difficult to control the amount thereof to the optimum value during toner production.

In addition, techniques have also been proposed for improving toner charging performance by modifying the resin component used in the toner.

Japanese Patent Application Laid-open No. 2012-145600 proposes a toner having superior electrical characteristics by using a polyester resin obtained by polycondensation of a carboxylic acid component and a polyvalent alcohol component derived from a sugar alcohol.

Since this toner uses an isosorbide unit as one of the components of the polyvalent alcohol, it is able to enhance inhibition of fogging. However, as a result of conducting extensive studies, the inventors of the present invention found that a decrease in image density occurs accompanying a decrease in toner charging performance in high-humidity environments. This is thought to be the result of a decrease in charge quantity due to hygroscopic properties unique to the isosorbide.

In addition, Japanese Patent Application Laid-open Nos. 2012-233037 and 2012-255083 propose a toner for which toner fixing performance, storability and durability are improved by using a polyester resin having an isosorbide unit.

In addition, Japanese Translation of PCT Application No. 2012-521567 proposes a toner that uses a polyester resin having an isosorbide unit from the viewpoint of environmental compatibility.

However, as a result of conducting extensive studies, the inventors of the present invention found that, although these toners certainly have superior fixing performance and storability, since they are still toners that incorporate an isosorbide unit for the main resin in the same manner as previously described, toner hygroscopic properties are enhanced and toner charge quantity tends to decrease. Based on the above reasons, there is currently a strong demand for a toner that demonstrates favorable charging performance and has superior appearance of the image with respect to image density, fogging and the like in various environments ranging from low-temperature, low-humidity environments to high-temperature, high-humidity environments.

### SUMMARY OF THE INVENTION

The present invention provides a toner having the optimum charge quantity and superior image density and inhibiting the occurrence of fogging in various environments ranging from low-temperature, low-humidity environments to high-temperature, high-humidity environments.

The present invention relates to:

a toner comprising a toner particle containing a resin,
wherein
the resin contains a styrene acrylic resin and a polyester resin A,
the content ratio of the styrene acrylic resin is from at least 50.0 mass % to not more than 99.0 mass % based on the resin,
the content ratio of the polyester resin A is from at least 1.0 mass % to not more than 35.0 mass % based on the resin, and
the polyester resin A contains an isosorbide unit represented by the following formula (1), the unit being contained in a molar ratio of from at least 0.10 mol % to not more than 30.0 mol % based on a total number of monomer units constituting the polyester resin A.

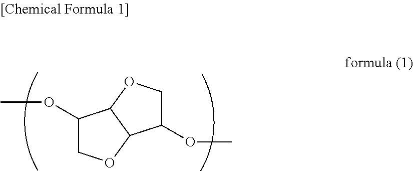

According to the present invention, a toner can be provided that has the optimum charge quantity and superior image density and inhibits the occurrence of fogging in various environments ranging from low-temperature, low-humidity environments to high-temperature, high-humidity environments.

Further features of the present invention will become apparent from the following description of exemplary embodiments (with reference to the attached drawings).

### BRIEF DESCRIPTION OF THE DRAWINGS

FIG. 1 is an enlarged view of the developing unit of an electrophotographic apparatus; and

FIG. 2 is a cross-sectional view of an electrophotographic apparatus.

### DESCRIPTION OF THE EMBODIMENTS

The toner of the present invention is:

a toner comprising a toner particle containing a resin,
wherein
the resin contains a styrene acrylic resin and a polyester resin A,
the content ratio of the styrene acrylic resin is from at least 50.0 mass % to not more than 99.0 mass % based on the resin,
the content ratio of the polyester resin A is from at least 1.0 mass % to not more than 35.0 mass % based on the resin, and
the polyester resin A contains an isosorbide unit represented by the following formula (1), the unit being contained in a molar ratio of from at least 0.10 mol % to not more than 30.0 mol % based on a total number of monomer units constituting the polyester resin A.

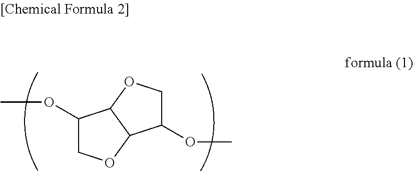

The toner of the present invention contains both a styrene acrylic resin and a polyester resin A that contains a specific amount of an isosorbide unit represented by the above-mentioned formula (1) as a constituent component thereof.

The charging performance of the toner can be improved by making the content ratio of the styrene acrylic resin to be from at least 50.0 mass % to not more than 99.0 mass % based on the resin in the toner.

More specifically, according to this configuration, the charge quantity of the toner can be optimized and the charge quantity distribution of the toner can be made to be sharp. As a result, in the case of using the toner of the present invention in a single component development system, images can be provided in which image density is favorable and the occurrence of fogging is inhibited.

As a result of having both a low-resistance polyester resin A and high-resistance styrene acrylic resin present in optimum amounts, the resistance value of the toner is optimized, and as a result thereof, charge quantity distribution of the toner is thought to become sharp. In addition, since hygroscopic properties of the toner can also be inhibited, toner charge quantity is also optimized.

In the case the content ratio of the styrene acrylic resin is less than 50 mass %, since the resistance properties of the polyester resin A become dominant, toner resistance becomes low and charge quantity distribution can be made to be sharp. However, the hygroscopic properties of the polyester resin A act strongly to lower the charge quantity of the toner. The content ratio of the styrene acrylic resin is preferably from at least 60 mass % to not more than 80 mass %. Furthermore, in the present invention, the content ratio of the styrene acrylic resin is represented as a ratio (mass %) based on the resin in the toner as previously described.

Namely, the content ratio of the styrene acrylic resin in the present invention is represented with the equation indicated below.

Content ratio of styrene acrylic resin=100×{styrene acrylic resin(mass)/resin in toner(mass)} (Equation)

In addition, the content ratio of the polyester resin A is similarly represented as the ratio of the polyester resin A based on the resin in the toner (mass %).

In the present invention, the styrene acrylic resin refers to a copolymer of a styrene monomer and an acrylic monomer. Examples of acrylic monomers include acrylic acid, methacrylic acid, and acrylic acid ester-based monomers and methacrylic acid-based monomers in the manner of methyl acrylate, methyl methacrylate, ethyl acrylate, ethyl methacrylate, propyl acrylate, propyl methacrylate, butyl acrylate, butyl methacrylate, octyl acrylate, octyl methacrylate, dodecyl acrylate, dodecyl methacrylate, stearyl acrylate, stearyl methacrylate, behenyl acrylate, behenyl methacrylate, 2-ethylhexyl acrylate, 2-ethylhexyl methacrylate, dimethylaminoethyl acrylate, dimethylaminoethyl methacrylate, diethylaminoethyl acrylate and diethylaminoethyl methacrylate.

In addition, an aromatic vinyl monomer other than the styrene monomer may also be used together with the styrene monomer and acrylic monomer. Examples of aromatic vinyl monomers include styrene derivatives such as o-methylstyrene, m-methylstyrene, p-methylstyrene, p-methoxystyrene, p-phenylstyrene, p-chlorostyrene, 3,4-dichlorostyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene or p-n-dodecylstyrene.

In the present invention, a crosslinking agent may be used to enhance toner mechanical strength as well as control the molecular weight of the styrene acrylic resin.

Examples of bifunctional crosslinking agents include divinylbenzene, bis(4-acryloxypolyethoxyphenyl)propane, ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, diethylene glycol diacrylate, triethylene glycol diacrylate, tetraethylene glycol diacrylate, diacrylates of polyethylene glycol #200, #400 and #600, dipropylene glycol diacrylate, polypropylene glycol diacrylate, polyester-type diacrylate (MANDA, Nippon Kayaku Co., Ltd.) and bifunctional crosslinking agents in which the aforementioned diacrylates have been substituted with dimethacrylates.

On the other hand, examples of polyfunctional crosslinking agents include pentaerythritol triacrylate, trimethylolethane triacrylate, trimethylolpropane triacrylate, tetramethylolmethane tetraacrylate, oligoester acrylates and polyfunctional crosslinking agents in which the aforementioned acrylates have been substituted with methacrylates, 2,2-bis(4-methacryloxypolyethoxyphenyl)propane, diallyl phthalate, triallyl cyanurate, triallyl isocyanurate and triallyl trimellitate.

In the present invention, the peak molecular weight (Mp) of the above-mentioned styrene acrylic resin is preferably from at least 5000 to not more than 30000 and more preferably from at least 8000 to not more than 27000.

In the case the peak molecular weight (Mp) of the styrene acrylic resin is less than 5000, molecular motion of the molecular chain of the polyester resin A present together with the styrene acrylic resin becomes large, hygroscopicity in a high-humidity environment tends to become high and toner charge quantity tends to decrease.

In addition, if the peak molecular weight (Mp) exceeds 30000, compatibility between the styrene acrylic resin and the polyester resin A tends to decrease, a large domain of the polyester resin A is easily formed in the toner, and the charge quantity distribution of the toner easily becomes broad.

In the present invention, the polyester resin A is such that it contains the above-mentioned isosorbide unit represented by formula (1), the unit being contained in a molar ratio of from at least 0.10 mol % to not more than 30.00 mol %, and preferably from at least 0.50 mol % to not more than 20.0 mol %, based on a total number of monomer units constituting the polyester resin A.

Since the isosorbide unit adopts a cyclic structure having an ether group within the unit, it has extremely high hygroscopic properties. In addition, as a result of this unit being incorporated in a polyester resin, the resistance value of the polyester resin can be made to be of the proper value.

In the present invention, toner charging performance is improved by utilizing the hygroscopic properties and resistance properties of this isosorbide unit.

As a result of making the molar ratio of the isosorbide unit in the polyester resin A to be within the above-mentioned ranges, interaction with the above-mentioned styrene acrylic resin acts effectively and toner charging performance improves remarkably.

In the case the molar ratio of the isosorbide unit is less than 0.10 mol %, since the ratio of the isosorbide unit present in the polymer chain of the polyester resin A is excessively low, the property of contributing to charging performance of the polyester resin A is impaired. More specifically, since the hygroscopic properties of the polyester resin A hardly act at all, the charge quantity of the toner in a low-humidity environment becomes excessively high and a decrease in image density occurs.

On the other hand, in the case the molar ratio of the isosorbide unit exceeds 30.00 mol %, block segments of the isosorbide unit are formed in the polymer chain of the polyester resin A, and since the hydroscopic properties of those segments act excessively strongly, the charge quantity of the toner in a high-humidity environment decreases considerably. In this case as well, a decrease in image density occurs in the same manner as in a low-humidity environment.

In the present invention, the content ratio of the polyester resin A is from at least 1.0 mass % to not more than 35.0 mass %, and preferably from at least 2.0 mass % to not more than 20.0 mass %, based on the resin.

In the case the content ratio of the polyester resin A is less than 1.0 mass %, interaction between the polyester resin A and the styrene acrylic resin does not act adequately and toner charging performance cannot be improved.

In addition, in the case the content ratio of the polyester resin A exceeds 35.0 mass %, since the effect of the polyester resin A acts excessively, hygroscopic properties of the toner become poor.

In the present invention, the acid value of the polyester resin A is preferably from at least 0.5 mgKOH/g to not more than 25.0 mgKOH/g, and more preferably from at least 1.5 mgKOH/g to not more than 20.0 mgKOH/g.

In the case the acid value of the polyester resin A is less than 0.5 mgKOH/g, compatibility with the styrene acrylic resin becomes excessively high, toner resistance value lowers and the charge quantity of the toner tends to decrease. On the other hand, if the acid value of the polyester resin A exceeds 25.0 mgKOH/g, compatibility with the styrene acrylic resin decreases easily, a large domain of the polyester resin A occurs easily in the toner particles, and the charge quantity distribution of the toner tends to become broad.

Furthermore, the acid value (mgKOH/g) of the polyester resin A can be controlled according to, for example, the monomer composite ratio at the time of polymerization.

In the present invention, the polyester resin A containing the isosorbide unit represented by formula (1) as a resin constituent component thereof can be prepared by, for example, a method that involves subjecting a dibasic acid or anhydride thereof (monomer), and an isosorbide represented by the following formula (2) and a divalent alcohol (monomer), to dehydration condensation at a composite ratio at which carboxyl groups remain and at a reaction temperature of 180° C. to 260° C. in a nitrogen atmosphere. In addition, a trifunctional or higher polybasic acid or anhydride thereof, a monobasic acid, a trifunctional or higher alcohol or a monovalent alcohol and the like can also be used as necessary.

Examples of the divalent alcohol include alkylene oxide adducts of bisphenol A in the manner of polyoxypropylene(2.2)-2,2-bis(4-hydroxyphenyl)propane, polyoxypropylene(3.3)-2,2-bis(4-hydroxyphenyl)propane, polyoxyethylene(2.0)-2,2-bis(4-hydroxyphenyl)propane, polyoxypropylene(2.0)-polyoxyethylene(2.0)-2,2-bis(4-hydroxyphenyl)propane and polyoxypropylene(6)-2,2-bis(4-hydroxyphenyl)propane, and aliphatic dials in the manner of ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol and polytetramethylene glycol.

Examples of trivalent or higher alcohols include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane and 1,3,5-trihydroxymethylbenzene.

On the other hand, examples of acid components such as the above-mentioned dibasic acid include aromatic polyvalent carboxylic acids in the manner of phthalic acid, isophthalic acid, terephthalic acid, trimellitic acid and pyromellitic acid, aliphatic polyvalent carboxylic acids in the manner of fumaric acid, maleic acid, adipic acid, succinic acid, succinic acid substituted with an alkyl group having 1 to 20 carbon atoms or an alkenyl group having 2 to 20 carbon atoms in the manner of dodecenyl succinic acid and octenyl succinic acid, anhydrides of these acids and alkyl (1 to 8 carbon atoms) esters of these acids. Among these, polyester resins can be used particularly preferably that are obtained by using a bisphenol derivative for the alcohol component, using a divalent or higher carboxylic acid, acid anhydride thereof or lower alkyl ester thereof for the acid component, and subjecting the alcohol component and acid component to condensation polymerization.

In the present invention, a conventionally known styrene-based resin, acrylic resin or polyester resin may also be used as resin in combination with the styrene acrylic resin and the polyester resin A.

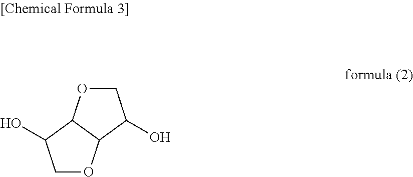

The toner of the present invention may also contain a colorant. A known colorant can be used for the colorant.

Examples of black colorants include carbon black, magnetic bodies and black colorants obtained by mixing colors using the yellow, magenta and cyan colorants indicated below.

Examples of yellow colorants include compounds represented by condensed azo compounds, isoindolinone compounds, anthraquinone compounds, azo metal complexes, methine compounds and allylamide compounds. Specific examples include the following C.I. Pigment Yellow 12, 13, 14, 15, 17, 62, 73, 74, 83, 93, 94, 95, 97, 109, 110, 111, 120, 128, 129, 138, 147, 150, 151, 154, 155, 168, 180, 185 and 214.

Examples of magenta colorants include condensed azo compounds, diketopyrrolopyrrole compounds, anthraquinone compounds, quinacridone compounds, basic dye lake compounds, naphthol compounds, benzimidazolone compounds, thioindigo compounds and perylene compounds. Specific examples include the following C.I. Pigment Red 2, 3, 5, 6, 7, 23, 48:2, 48:3, 48:4, 57:1, 81:1, 122, 146, 150, 166, 169, 177, 184, 185, 202, 206, 220, 221, 238, 254 and 269, and C.I. Pigment Violet 19.

Examples of cyan colorants include copper phthalocyanine compounds and derivatives thereof, anthraquinone compounds and basic dye lake compounds. Specific examples include C.I. Pigment Blue 1, 7, 15, 15:1, 15:2, 15:3, 15:4, 60, 62 and 66. These colorants can be used alone or mixed, and can also be used in the form of a solid solution. The colorant is selected from the viewpoints of hue angle, chroma, lightness, lightfastness, OHP transparency and dispersibility in the toner. The added amount of the above-mentioned colorant is preferably from at least 1 mass part to not more than 20 mass parts based on 100 mass parts of resin.

The toner of the present invention can also be a magnetic toner containing a magnetic material. In this case, the magnetic material can also fulfill the role of a colorant.

Examples of magnetic materials include the following iron oxides in the manner of magnetite, hematite and ferrite, metals in the manner of iron, cobalt and nickel, and alloys of these metals and metals in the manner of aluminum, cobalt, copper, lead, magnesium, tin, zinc, antimony, beryllium, bismuth, cadmium, calcium, manganese, selenium, titanium, tungsten and vanadium, as well as mixtures thereof.

The magnetic material is preferably subjected to surface modification. In the case of preparing magnetic toner by a suspension polymerization method, the magnetic toner is preferably subjected to hydrophobic treatment with a surface modifier that does not inhibit polymerization. Examples of such surface modifiers include silane coupling agents and titanium coupling agents.

The number average particle diameter of the magnetic material is preferably 2 μm or less and more preferably at least 0.1 μm to not more than 0.5 μm. The content of the magnetic material in the toner is preferably at least 20 mass parts to not more than 200 mass parts, and more preferably at least 40 mass parts to not more than 150 mass parts, based on 100 mass parts of resin.

The toner of the present invention may also contain a wax. Examples of wax include petroleum-based waxes and derivatives thereof in the manner of paraffin wax, microcrystalline wax and petrolactum, montan waxes and derivatives thereof, hydrocarbon waxes obtained according to the Fischer-Tropsch method and derivatives thereof, polyolefin waxes and derivatives thereof in the manner of polyethylene wax and polypropylene wax, and natural waxes and derivatives thereof in the manner of carnauba wax and candelilla wax. Examples of derivatives include oxides, block copolymers with vinyl-based monomers and graft denaturation products. Additional examples include higher aliphatic alcohols, fatty acids in the manner of stearic acid and palmitic acid, acid amide waxes, ester waxes, hydrogenated castor oil and derivatives thereof, plant-based waxes and animal waxes. Among these, ester waxes and hydrocarbon waxes are particularly preferable from the viewpoint of superior mold releasability. More preferably, the wax preferably contains at least 50 mass % not more than to 95 mass % of a compound having the same total number of carbon atoms from the viewpoints of high wax purity and developability.

The content of the wax is preferably at least 1 mass part to not more than 40 parts, and more preferably at least 3 mass parts to not more than 25 mass parts, based on 100 mass parts of resin.

In the case the wax content is at least 1 mass part to not more than 40 mass parts, resistance to wraparound at high temperatures improves as a result of allowing the wax to bleed suitably during toner heating and pressurization. Moreover, exposure of wax on the toner surface can be reduced and uniform charging performance of individual toner particles can be obtained even if the toner is subjected to stress during development and transfer.

In a preferable mode thereof, the toner of the present invention has inorganic fine particles externally added to the toner particles for the purpose of improving toner flowability and the like.

The inorganic fine particles externally added to the toner particles preferably at least include silica fine particles. The number average particle diameter of primary particles of the silica fine particles is preferably at least 4 nm to not more than 80 nm. As a result of making the number average particle diameter of primary particles of the silica fine particles to be within the above-mentioned range, toner flowability improves and toner storage stability also becomes favorable.

The number average particle diameter of primary particles of the inorganic fine particles is determined by observing with a scanning electron microscope, measuring the particle diameter of primary particles of 100 inorganic fine particles in a field, and calculating the arithmetic mean.

Fine particles of titanium oxide, alumina or compound oxides thereof can be used for the inorganic fine particles in combination with silica fine particles. Titanium oxide is preferably used for the inorganic fine particles used in combination with the silica fine particles. The silica fine particles include both fine particles of dry silica or dry silica referred to as fumed silica formed by vapor phase oxidation of a silicon halide, and wet silica produced from water glass. Dry silica is preferable for the silica since it has few silanol groups on the surface or inside the silica and results in little Na₂O and SO₃²⁻ production residue. In addition, dry silica allows the obtaining of composite fine particles of silica and other metal oxides by using another metal halide such as aluminum chloride or titanium chloride with the silicon halide in the production process. These are also contained in silica.

Inorganic fine particles are also added to make the triboelectric charge performance of the toner uniform. Since subjecting the inorganic fine particles to hydrophobic treatment makes it possible to impart functions such as adjustment of toner triboelectric charge quantity, improvement of environmental stability and improvement of characteristics in high-humidity environments, fine inorganic particles that have undergone hydrophobic treatment are used preferably. If inorganic fine particles that have been externally added to toner particles absorb moisture, triboelectric charge quantity of the toner decreases easily and decreases in developability and transferability occur easily.

Examples of treatment agents for carrying out hydrophobic treatment on inorganic fine particles include unmodified silicone varnish, various types of modified silicone varnishes, unmodified silicone oil, various types of modified silicone oils, silane compounds, silane coupling agents, other organic silicon compounds and organic titanium compounds. These treatment agents may be used alone or in combination.

Among these, inorganic fine particles treated with silicone oil are preferable. Hydrophobically treated inorganic fine particles that have been treated with silicone oil either simultaneous to hydrophobic treatment with a coupling agent or after hydrophobic treatment with a coupling agent are more preferable in that they are able to maintain a high triboelectric charge quantity and reduce selective developability of the toner particles even in a high-humidity environment.

The added amount of the inorganic fine particles is normally at least 0.01 mass parts to not more than 10 mass parts, and preferably at least 0.05 mass parts to not more than 5 mass parts, based on 100 mass parts of toner particles.

There are no particular limitations on the method used to produce the toner of the present invention, and a conventionally known method such as a suspension polymerization method, dissolution suspension method, emulsion aggregation method or pulverization method can be used. Among the above-mentioned methods, the suspension polymerization method makes it easy to control the states of the styrene acrylic resin and polyester resin A present near the toner surface by balancing the polarity between water and the toner material. Consequently, the suspension polymerization method is more preferable in terms of allowing the obtaining of favorable toner charging performance.

The following provides an explanation of a toner particle production method using the suspension polymerization method.

First, a polymerizable monomer composition containing polymerizable monomers that form the styrene acrylic resin and the polyester resin A, and other components such as a colorant as necessary, is dispersed in an aqueous medium to form particles of the polymerizable monomer composition, followed by polymerizing the polymerizable monomers contained in the particles. The particles obtained by polymerization then go through filtration, washing and drying steps to obtain toner particles.

A dispersing agent may be added to the aqueous medium to form particles of the polymerizable monomer composition after having uniformly dispersed the polymerizable monomer composition.

In the case of the suspension polymerization method, styrene monomer and acrylic monomer may be used for the polymerizable monomers and styrene acrylic resin may be added in advance when carrying out suspension polymerization as a method for adjusting the content of styrene acrylic resin in the toner.

A polymerization initiator used in the suspension polymerization method may be added to the polymerizable monomers simultaneous to the addition of other additives, or may be mixed into to the aqueous medium immediately prior to the formation of particles of the polymerizable monomer composition. In addition, the polymerization initiator dissolved in the polymerizable monomers or a solvent may be added immediately after the formation of particles but prior to the start of the polymerization reaction.

Examples of the polymerization initiator include azo-based or diazo-based polymerization initiators in the manner of 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile and azobisisobutyronitrile, and peroxide-based polymerization initiators in the manner of benzoyl peroxide, methyl ethyl ketone peroxide, diisopropyl peroxycarbonate, cumene hydroperoxide, 2,4-dichlorobenzoyl peroxide, lauroyl peroxide and tert-butyl peroxypivalate.

In general, although varying according to the target degree of polymerization, the amount of these polymerization initiators used is preferably at least 3 mass parts to not more than 20 mass parts based on 100 mass parts of the above-mentioned polymerizable monomers. Although varying slightly according to the purpose, the type of polymerization initiator is selected with reference to the 10-hour half-life temperature, and is used alone or as a mixture.

A known inorganic or organic dispersing agent can be used for the dispersing agent used to disperse the above-mentioned polymerizable monomer composition in an aqueous medium.

Examples or inorganic dispersing agents include tricalcium phosphate, magnesium phosphate, aluminum phosphate, zinc phosphate, magnesium carbonate, calcium carbonate, calcium hydroxide, magnesium hydroxide, aluminum hydroxide, calcium metasilicate, calcium sulfate, barium sulfate, bentonite, silica and alumina.

On the other hand, examples of organic dispersing agents include polyvinyl alcohol, gelatin, methyl cellulose, methyl hydroxypropyl cellulose, ethyl cellulose, carboxymethyl cellulose sodium salt and starch.

In addition, commercially available nonionic, anionic and cationic surfactants can also be used as dispersing agents for dispersing the polymerizable monomer composition in an aqueous medium. Examples of such surfactants include sodium dodecyl sulfate, sodium tetradecyl sulfate, sodium pentadecyl sulfate, sodium octyl sulfate, sodium oleate, sodium laurate, potassium stearate and calcium oleate.

Among these dispersing agents for dispersing the above-mentioned polymerizable monomer composition in an aqueous medium, inorganic, poorly water-soluble dispersing agents are preferable, and the use of poorly water-soluble inorganic dispersing agents that are soluble in acid is more preferable.

The amount of the dispersing agent used is preferably at least 0.2 mass parts to not more than 2.0 mass parts based on 100 mass parts of the polymerizable monomers. In addition, the aqueous medium is preferably prepared using at least 300 mass parts to not more than 3000 mass parts of water based on 100 mass parts of the polymerizable monomer composition. In the present invention, in the case of preparing an aqueous medium in which a poorly water-soluble inorganic dispersing agent is dispersed in the manner described above, it may be dispersed by using a commercially available dispersing agent as is. In addition, in order to obtain particles of dispersing agent having a fine, uniform particle size, the particles may be prepared by forming a poorly water-soluble inorganic dispersing agent in an aqueous medium while stirring rapidly. For example, in the case of using tricalcium phosphate for the dispersing agent, fine particles of tricalcium phosphate are formed by mixing an aqueous sodium phosphate solution and aqueous calcium chloride solution while stirring rapidly.

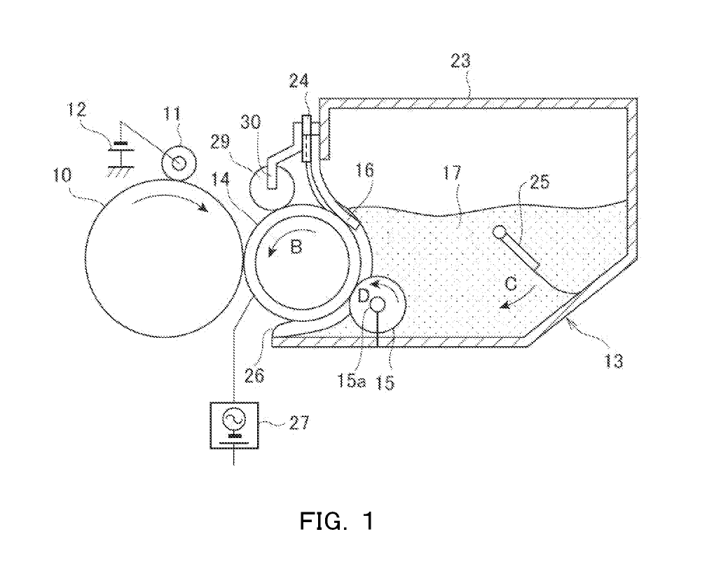

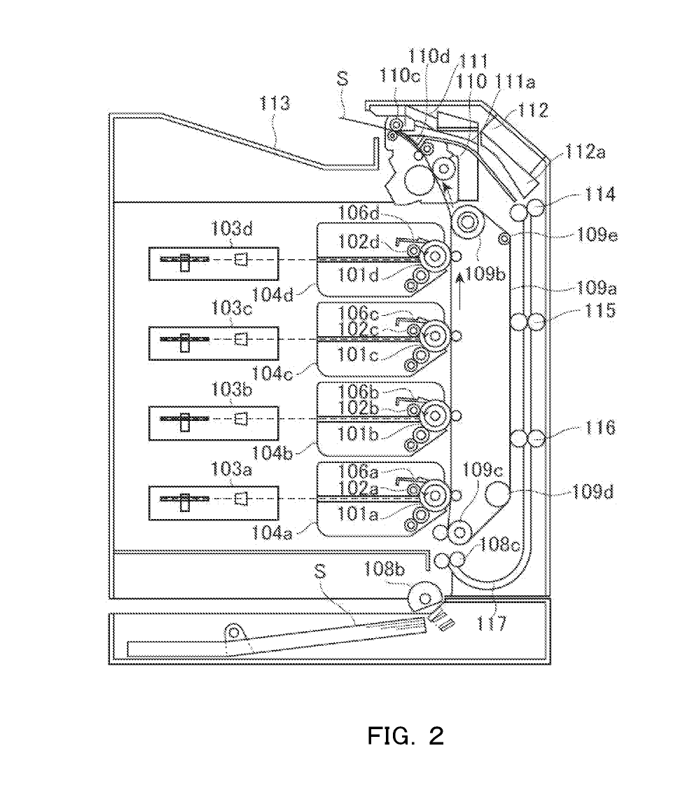

Next, an explanation is provided of an image-forming method used in the present invention using FIG. 1 and FIG. 2.

The configuration of an image-forming apparatus that comprises the image-forming method used in examples of the present application is shown in FIG. 2. The image-forming apparatus shown in FIG. 2 is a laser beam printer that uses a transfer-type electrophotographic process. FIG. 2 shows a cross-sectional view of a tandem-type color laser beam printer (LBP) in particular.

In FIG. 2, reference symbols 101 (101a to 101d) indicate latent image bearing members in the form of electrophotographic photosensitive drums (to be simply referred to as photosensitive drums) that rotate at a prescribed process speed in the direction indicated with the arrow (counter-clockwise direction). The photosensitive drums 101a, 101b, 101c and 101d are respectively responsible for the yellow (Y) component, magenta (M) component, cyan (C) component and black (B) component of color images in that order.

Each of the image-forming apparatuses for Y, M, C and Bk are respectively referred to as Unit a, Unit b, Unit c and Unit d.

Although these photosensitive drums 101a to 101d are driven by being rotated by a drum motor (direct current servo motor) not shown, drive sources may also be provided separately and independently for each of the photosensitive drums 101a to 101d. Furthermore, driving by the drum motor is controlled by a digital signal processor (DSP) not shown, and other control is carried out by a CPU not shown.

In addition, an electrostatically attracting transport belt 109a is stretched between a driver roller 109b, stationary rollers 109c and 109e and a tension roller 109d, is driven to rotate in the direction indicated by the arrow in the drawing by being driven by the driver roller 109b, and transports a recording medium S by attracting thereto.

The following provides an explanation of the image-forming apparatus using the example of Unit a (yellow) among the four colors.

The photosensitive drum 101a is uniformly subjected to primary charging treatment to a prescribed polarity and potential by a primary charging means 102a during the course of the rotation thereof. The photosensitive drum 101a is then exposed with a laser beam exposure means (to be referred to as a scanner) 103a and an electrostatic latent image of the image information is formed on the above-mentioned photosensitive drum 101a.

Next, a toner image is formed on the photosensitive drum 101a by a developing unit 104a and an electrostatic latent image becomes visible. The same steps are carried out for each of the other three colors (magenta (M), cyan (C) and black (Bk)).

The toner images of four colors are then sequentially transferred to the recording medium S at nip portions between the photosensitive drums 101a to 101d and the electrostatically attracting transport belt 109a by synchronizing stopping and resumed transport of the recording medium S, transported by a supply roller 108b at a prescribed timing, with a registration roller 108c. In addition, simultaneous thereto, the photosensitive drums 101a to 101d after having transferred the toner image to the recording medium S are removed of residual adhered substances such as untransferred toner by cleaning means 106a, 106b, 106c and 106d and then repeatedly used to form images.

Following transfer of toner images from the four photosensitive drums 101a to 101d, the recording medium S is separated from the surface of the electrostatically attracting transport belt 109a at the driver roller 109b and is sent to a fixing unit 110 where the toner image is fixed by the fixing unit 110, after which the recording medium S is discharged to a discharge tray 113 by a discharge roller 110c.

Next, an explanation is provided of a specific example of an image-forming method using a non-magnetic, single-component contact development system that can be applied to the present invention using an enlarged view of a developing unit (FIG. 1). In FIG. 1, a developing unit 13 is provided with a developer container 23, which houses a single-component developer in the form of a non-magnetic toner 17, and a toner carrying member 14 positioned in opposition to the latent image bearing member (photosensitive drum) 10, which is positioned in an opening extending in the lengthwise direction within the developer container 23, and electrostatic latent images become visible by developing on the latent image bearing member 10. A latent image bearing member contact charging member 11 is in contact with the latent image bearing member 10. Bias of the latent image bearing member contact charging member 11 is applied by a power supply 12.

Roughly half of the right circumferential surface of the toner carrying member 14 shown in the drawing protrudes into the developer container 23 at the above-mentioned opening, while roughly half of the left circumferential surface is provided horizontally exposed outside the developer container 23. The surface that is exposed outside the developer container 23 contacts the latent image bearing member 10 located to the left of center in the drawing in the developing unit 13 as shown in FIG. 1.

The toner carrying member 14 is driven to rotate in the direction indicated by arrow B, the peripheral velocity of the latent image bearing member 10 is 50 m/s to 170 m/s, and the toner carrying member 14 is rotated at a peripheral velocity 1 to 2 times faster than the peripheral velocity of the latent image bearing member 10.

A regulating member 16, which uses a metal plate made of SUS and the like, a rubber material such as urethane or silicone, or a metal thin plate having resilient elasticity made of SUS or phosphor bronze, for the substrate, and is composed of a rubber material adhered to the side that contacts the toner carrying member 14, is supported by a regulating member supporting metal sheet 24 at a location above the toner carrying member 14, is provided so that the vicinity of the end on the free end side thereof contacts the outer peripheral surface of the toner carrying member 14 by surface contact, and the direction of that contact is the so-called counter direction in which the end side is located on the upstream side in the direction of rotation of the toner carrying member 14 with respect to the contact region. One example of the regulating member 16 has a configuration in which the regulating member supporting metal sheet 24 is adhered to urethane rubber in the form of a sheet having a thickness of 1.0 mm, and the contact pressure (linear pressure) with respect to the toner carrying member 14 is set as is suitable. The contact pressure is preferably 20 N/m to 300 N/m. Furthermore, contact pressure is measured by inserting three metal thin plates having a known coefficient of friction into the contact region and converting from the value obtained when pulling out the center plate with a spring balance. Furthermore, the regulating member 16 preferably has a rubber material and the like adhered to the side of the contact surface in terms of adhesive property with toner since melt adhesion and fixation of toner to the regulating member during the course of long-term use can be inhibited. In addition, the state of contact of the regulating member 16 with the toner carrying member 14 can also be made to be edge contact in which contact is made with the end of the regulating member 16. Furthermore, in the case of edge contact, the contact angle of the regulating member with respect to the tangent of the toner carrying member at the point of contact with the toner carrying member is preferably set to 40 degrees or less from the viewpoint of toner layer regulation.

A toner supply roller 15 is rotatably supported, the toner supply roller 15 being contacted with the toner carrying member 14 on the upstream side in the direction of rotation of the toner carrying member 14 with respect to the contact region of the regulating member 16 with the surface of the toner carrying member 14. The contact width of this toner supply roller 15 with respect to the toner carrying member 14 is effectively 1 mm to 8 mm, and is preferably given a velocity relative to the toner carrying member 14 at the contact region therewith.

A charging roller 29 is preferably, although not essentially, installed in the image-forming method of the present invention. The charging roller 29 is an elastic body made of NBR or silicone rubber and the like, and is attached to a suppressing member 30. The contact load of the charging roller 29 applied to the toner carrying member 14 by this suppressing member 30 is set to 0.49 N to 4.9 N. As a result of this contact by the charging roller 29, a toner layer on the toner carrying member 14 is precisely filled and uniformly coated. The lengthwise positional relationship between the regulating member 16 and the charging roller 29 is preferably such that they are arranged so that the charging roller 29 is able to reliably cover the entire contact region of the regulating member 16 on the toner carrying member 14.

In addition, the charging roller 29 is required to be driven so as to follow the rotation of the toner carrying member 14 or to be driven at the same peripheral velocity as the toner carrying member 14, and a difference in peripheral velocity between the charging roller 29 and the toner carrying member 14 results in uneven toner coating and unevenness in the resulting images, thereby making this undesirable.

Bias of the charging roller 29 is applied by a power supply 27 as direct current between the toner carrying member 14 and the latent image bearing member 10 (reference symbol 27 in FIG. 1), and the non-magnetic toner 17 on the toner carrying member 14 is charged by the charging roller 29 by electrical discharge.

Bias of the charging roller 29 refers to bias equal to or greater than a discharge starting voltage of the same polarity as that of the non-magnetic toner, and is set so as to generate a potential difference of 1000 V to 2000 V with respect to the toner carrying member 14. After having been charged by the charging roller 29, a toner layer formed in a thin layer on the toner carrying member 14 is uniformly transported to the developing part located in opposition to the latent image bearing member 10.

In the developing part, the toner layer formed in a thin film on the toner carrying member 14 is developed in the form of a toner image for the electrostatic latent image on the latent image bearing member 10 due to the direct current bias applied between the toner carrying member 14 and the latent image bearing member 10 by the power supply 27 shown in FIG. 1.

The following provides an explanation of methods for measuring physical properties according to the toner of the present invention.

<Measurement of Resin and Other Molecular Weight Distribution>

The weight-average molecular weight (Mw), number average molecular weight (Mn) and peak molecular weight (Mp) of the resin and other components is measured under the conditions indicated below using gel permeation chromatography (GPC). After stabilizing the column in a heat chamber at 40° C., a solvent in the form of tetrahydrofuran (THF) is passed through the column at this temperature at a flow rate of 1 ml per minute. A plurality of commercially available polystyrene columns were combined to accurately measure a molecular weight range from 1×10³ to 2×10⁶. The combination of Shodex GPC columns KF-801, 802, 803, 804, 805, 806, 807 and 800P manufactured by Showa Denko K.K., or the combination of TSK gel columns G1000H(HXL), G2000H(HXL), G3000H(HXL), G4000H(HXL), G5000H(HXL), G6000H(HXL), G7000H(HXL) and TSKguard column manufactured by Tosoh Corp. is used. A combination of seven columns formed of the Shodex KF-801, 802, 803, 804, 805, 806 and 807 manufactured by Showa Denko K.K. was used in the present application.

On the other hand, after dispersing and dissolving the resin and the like in THF and allowing to stand undisturbed overnight, the solution is filtered with a sample treatment filter (pore size: 0.2 μm to 0.5 μm, Maishori Disc H-25-2 (Tosoh Corp.)) and the filtrate is used for the sample. 50 μl to 200 μl of the THF resin solution, adjusted so that the resin component is 0.5 mg to 5 mg for the sample concentration, is injected and measured. Furthermore, a refractive index (RI) detector is used for the detector.

In measuring the molecular weight of a sample, molecular weight distribution of the sample is calculated from the relationship between the number of counts and the logarithmic value of a calibration curve prepared from a plurality of types of monodispersed polystyrene standard samples. Standard polystyrene samples having molecular weights of 6×10², 2.1×10³, 4×10³, 1.75×10⁴, 5.1×10⁴, 1.1×10⁵, 3.9×10⁵, 8.6×10⁵, 2×10⁶ and 4.48×10⁶ manufactured by Pressure Chemical Co. or Tosho Corp. are used to prepare the calibration curve, and standard polystyrene samples are used for at least about 10 measurement points.

<Measurement of Acid Value of Polyester Resin A>

The acid value of polyester resin A is determined according to the following procedure. Acid value is the number of mg of potassium hydroxide required to neutralize the acid contained in 1 g of sample. Although the basic procedure is carried out in compliance with JIS K0070-1992, more specifically, acid value is measured in accordance with the procedure indicated below.

(1) Reagent Preparation

1.0 g of phenolphthalein is dissolved in 90 ml of ethyl alcohol (95 vol %) followed by the addition of ion exchange water to bring to a volume of 100 ml and obtain a phenolphthalein solution.

7 g of special grade potassium hydroxide are dissolved in 5 ml of water followed by the addition of ethyl alcohol (95 vol %) to bring to a volume of 1 L. After placing in an alkaline-resistant container so as to prevent contact with carbon dioxide gas and the like and allowing to stand for 3 days, the solution is filtered to obtain a potassium hydroxide solution. The resulting potassium hydroxide solution is stored in an alkaline-resistant container. The factor of the above-mentioned potassium hydroxide solution is determined by placing 25 ml of 0.1 mol/L hydrochloric acid in an Erlenmeyer flask, adding several drops of the above-mentioned phenolphthalein solution, titrating with the above-mentioned potassium hydroxide solution, and determining the factor from the amount of the above-mentioned potassium hydroxide solution required to neutralize the solution. The above-mentioned 0.1 mol/L hydrochloric acid used is prepared in compliance with JIS K 8001-1998.

(2) Procedure

(A) Actual Test

2.0 g of pulverized polyester resin A are accurately weighed out in a 200 ml Erlenmeyer flask followed by the addition of 100 mL of a mixed solvent of toluene and ethanol (2:1) and dissolving over the course of 5 hours. Next, several drops of indicator in the form of the above-mentioned phenolphthalein solution are added followed by titrating using the above-mentioned potassium hydroxide solution. Furthermore, the titration endpoint is taken to be the point at which the feint pink color of the indicator persists for about 30 seconds.

(B) Blank Test

Titration is carried out in the same manner as the above-mentioned procedure with the exception of not using a sample (namely, using only the mixed solution of toluene and ethanol (2:1)).

(3) Acid value is calculated by substituting the results obtained into the following equation:

A=[(C−B)×f×5.61]/S

(wherein, A represents acid value (mgKOH/g), B represents the amount of potassium hydroxide solution added in the blank test (ml), C represents the amount of potassium hydroxide solution added in the actual test (ml), f represents the factor of the potassium hydroxide solution, and S represents the amount of sample (g)).

<Calculation Method of Content Ratios of Styrene Acrylic Resin and Polyester Resin A with Respect to Resin in Toner, and Calculation Method of Molar Ratio of Isosorbide Unit in Polyester Resin A>

A thermal-decomposition gas chromatograph mass spectrometer (thermal-decomposition GC/MS) and NMR are used to analyze the content ratios of the resins and the molar ratio of the isosorbide unit. Furthermore, in the present invention, only components having a molecular weight of 1500 or higher were measured. This is because components having a molecular weight of less than 1500 are thought to contain a high ratio of wax and hardly contain any resin components.

Although thermal-decomposition GC/MS makes it possible to determine constituent monomers of all resins present in toner as well as determine the peak area of each monomer, standardization of peak intensity using a sample having a known concentration to serve as a reference is required to carry out quantification. On the other hand, NMR makes it possible to determine and quantify constituent monomers without using a sample having a known concentration. Therefore, determination of constituent monomers is carried out while comparing the spectra of both NMR and thermal-decomposition GC/MS corresponding to the particular circumstances.

More specifically, quantification is carried out by measurement of NMR in the case the amount of resin components that do not dissolve in deuterated chloroform, which is the extraction solvent used during NMR measurement, is less than 5.0 mass %.

On the other hand, both NMR and thermal-decomposition GC/MS are carried out on deuterated chloroform-soluble matters and thermal-decomposition GC/MS is carried out on deuterated chloroform-insoluble matters in the case the amount of resin components that do not dissolve in deuterated chloroform, which is the extraction solvent used during NMR measurement, is 5.0 mass % or more. In this case, NMR measurement is first carried out on deuterated chloroform-soluble matters to determine and quantify constituent monomers (Quantification Result 1). Next, thermal-decomposition GC/MS measurement is carried out on deuterated chloroform-soluble matters to determine the peak area of the peak assigned to each constituent monomer. The relationship between the amount of each constituent monomer and the peak area as determined by thermal-decomposition GC/MS is then determined using the Quantification Result 1 obtained by NMR measurement. Next, thermal-decomposition GC/MS measurement is carried out on deuterated chloroform-insoluble matters followed by determining the peak area of the peak assigned to each constituent monomer. Constituent monomers in deuterated chloroform-insoluble matters are then quantified from the relationship between the amount of each constituent monomer and the peak area of thermal-decomposition GC/MS obtained during measurement of the deuterated chloroform-soluble matters (Quantification Result 2). Quantification Result 1 and Quantification Result 2 are then combined to finally quantify the amount of each constituent monomer.

More specifically, the procedure indicated below is carried out.

(1) 500 mg of toner are accurately weighed in a 30 mL glass sample bottle followed by the addition of 10 mL of deuterated chloroform, covering the bottle and dissolving by dispersing for 1 hour with an ultrasonic disperser. Next, the solution is filtered with a 0.4 μm diameter membrane filter followed by recovery of the filtrate. At this time, deuterated chloroform-insoluble matters remain on the membrane filter.

(2) Components having a molecular weight of less than 1500 present in 3 mL of the filtrate are removed with a fraction collector using preparative high-performance liquid chromatography (HPLC), and the resin solution from which components having a molecular weight of less than 1500 have been removed is recovered. Chloroform is then removed from the recovered resin solution using a rotary evaporator to obtain resin. Furthermore, those components having a molecular weight of less than 1500 are determined by determining elution time by preliminarily measuring a polystyrene resin having a known molecular weight.

(3) 20 mg of the resulting resin is dissolved in 1 mL of deuterated chloroform followed by carrying out ¹H-NMR measurement to determine a quantitative value by assigning a spectrum to each constituent monomer used in the styrene acrylic resin and polyester resin.

(4) If analysis of deuterated chloroform-insoluble matters is required, analysis is carried out by thermal-decomposition GC/MS. Derivative treatment such as methylation is carried out as necessary.

<NMR Measuring Conditions>

Apparatus: Bruker AVANCE 500 (Bruker BioSpin K.K.)

Measured nucleus: ¹H

Measurement frequency: 500.1 MHz

Number of scans: 16

Measuring temperature: Room temperature

<Thermal-Decomposition GC/MS Measuring Conditions>

Thermal decomposition apparatus: TPS-700 (Japan Analytical Industry Co., Ltd.)

Thermal decomposition temperature: Appropriate value from 400° C. to 600° C., 590° C. in the present invention

GC/MS apparatus: ISQ (Thermo Fisher Scientific, K.K.)

Column: HP5-MS (Agilent Technologies, 19091S-433), length: 30 m, inner diameter: 0.25 mm, wall thickness: 0.25 μm

GC/MS Conditions

Injection port conditions:

Inlet temperature: 250° C.

Split flow rate: 50 ml/min

GC heating conditions: 40° C. (5 min)→10° C./min (300° C.)→300° C. (20 min)

Mass range: m/z=10 to 550

NMR measurement results for the toner produced in Toner Production Example 1 are indicated below as an example of NMR measurement results. Furthermore, the toners obtained in the toner production examples to be subsequently described contained hardly any deuterated chloroform-insoluble matters and the content thereof was less than 5.0 mass %.

<NMR Analysis Results>

Styrene: 72.31 mass %, butyl acrylate: 23.99 mass %, terephthalic acid: 0.68 mass %, isophthalic acid: 0.67 mass %, trimellitic acid: 0.02 mass %, bisphenol A-PG adduct: 1.66 mass %, bisphenol A-EO adduct: 0.40 mass %, isosorbide: 0.27 mass %

Accordingly, the content ratio of the styrene acrylic resin was 96.3 mass % and the content ratio of the polyester resin A was 3.7 mass %.

In addition, the molar ratios of each component based on the total number of monomer units constituting the polyester resin A are as indicated below.

Terephthalic acid: 23.62 mol %, isophthalic acid: 23.20 mol %, trimellitic acid: 0.68 mol %, bisphenol A-PG adduct: 33.65 mol %, bisphenol A-EO adduct: 8.35 mol %, isosorbide: 10.50 mol %

### Examples

Although the following provides a more detailed explanation of the present invention through the examples and comparative examples indicated below, the present invention is not limited by the examples and comparative examples. Furthermore, the terms “parts” and “%” described in the examples and comparative examples are all based on mass unless specifically indicated otherwise.

<Polyester Resin A Production Example 1>

100 mass parts of a mixture obtained by mixing raw material monomers other than trimellitic anhydride in the charged amounts shown in Table 1 and 0.52 mass parts of a catalyst in the form of bis(2-ethylhexanoic acid) tin were placed in a 6-liter, four-mouth flask equipped with a nitrogen feed tube, dehydration tube, stirrer and thermocouple and allowed to react for 6 hours at 200° C. in a nitrogen atmosphere. Moreover, trimellitic anhydride was added at 210° C. followed by carrying out the reaction under reduced pressure at 40 kPa and continuing to react until the weight-average molecular weight (Mw) reached 12000. The resulting polyester resin A was designated as Resin (1). The composition of Resin (1) is shown in Table 1. In addition, the acid value (mgKOH/g) of the resulting resin was as shown in Table 1.

<Polyester Resin A Production Examples 2 to 8>

Production Examples 2 to 8 were produced in the same manner as Polyester Resin A Production Example 1 with the exception of changing the charged amounts of the acid component and alcohol component as shown in Table 1. The resulting polyester resins A were designated as Resins (2) to (8). The acid values of the resulting Resins (2) to (8) are also shown in Table 1.

TABLE 1

| | | | Resin | Resin | Resin | Resin | Resin | Resin | Resin | Resin |
|---|---|---|---|---|---|---|---|---|---|---|
| | | | (1) | (2) | (3) | (4) | (5) | (6) | (7) | (8) |
| Monomer | Acid | TPA | 45.00 | 45.20 | 45.20 | 42.10 | 48.60 | 45.20 | 45.20 | 45.20 |
| composition* | | IPA | 44.20 | 43.80 | 44.00 | 41.20 | 45.20 | 44.10 | 44.10 | 44.10 |
| (molar ratio) | | TMA | 1.30 | 1.30 | 1.30 | 1.30 | 1.30 | 1.30 | 1.30 | 1.30 |
| | Alcohol | BPA(PO) | 64.00 | 69.00 | 22.00 | 55.20 | 54.40 | 68.50 | 17.20 | 79.00 |
| | (total = | BPA(EO) | 16.00 | 25.00 | 23.00 | 25.60 | 25.70 | 30.50 | 17.80 | 20.40 |
| | 100) | Isosorbide | 20.00 | 6.00 | 55.00 | 19.20 | 19.90 | 0.10 | 63.20 | 0.60 |

| | | | | | | | | |
|---|---|---|---|---|---|---|---|---|
| Isosorbide unit (mol %) | 10.50 | 3.15 | 28.87 | 10.40 | 10.20 | 0.05 | 33.47 | 0.31 |
| Resin acid value | 7.0 | 7.2 | 6.8 | 0.3 | 26.1 | 6.5 | 8.2 | 7.2 |

Monomer compositions are indicated as the molar ratios based on a value of 100 for the total number of moles of the alcohol component.

TPA: Terephthalic acid

IPA: Isophthalic acid

TMA: Trimellitic acid

BPA(PO): 3-mole propylene oxide adduct of bisphenol A

BPA(EO): 2-mole ethylene oxide adduct of bisphenol A

<Toner Production Example 1>

Toner (A) was produced according to the procedure indicated below.

850 mass parts of a 0.1 mol/L aqueous Na₃PO₄ solution were placed in a container equipped with a Clearmix high-speed stirring apparatus (M Technique Co., Ltd.) followed by adjusting the rotating speed to 15000 rpm and heating to 60° C. 68 mass parts of a 1.0 mol/L aqueous CaCl₂ solution were added thereto to prepare an aqueous medium containing a fine, sparingly water-soluble dispersing agent Ca₃ (PO₄)₂. In addition, the following materials were dissolved with a propeller-type stirring apparatus at 100 r/min to prepare a solution.

| | | |
|---|---|---|
| Styrene | 75.0 | mass parts |
| Acrylic monomer (n-butyl acrylate) | 25.0 | mass parts |
| Resin (1) | 3.8 | mass parts |

Next, the following materials were added to the above-mentioned solution.

| | | |
|---|---|---|
| C.I. Pigment Blue 15:3 | 6.5 | mass parts |
| Hydrocarbon wax (peak temperature of | 9.0 | mass parts |
| maximum endothermic peak: 77° C., | | |
| HNP-51, Nippon Seiro Co., Ltd.) | | |

Subsequently, the mixture was stirred at 9000 r/min with a TK Homomixer (Tokushu Kika Kogyo Co., Ltd.) after heating to a temperature of 60° C.

10.0 mass parts of a polymerization initiator in the form of 2,2′-azobis(2,4-dimethylvaleronitrile) were dissolved therein to prepare a polymerizable monomer composition. The above-mentioned polymerizable monomer composition was added to the above-mentioned aqueous medium followed by granulating for 15 minutes while rotating the Clearmix stirring apparatus at 15000 rpm at a temperature of 60° C.

Subsequently, after transferring to a propeller-type stirring apparatus and reacting for 5 hours at a temperature of 70° C. while stirring at 100 r/min, the temperature was raised to 80° C. followed by further reacting for 5 hours to produce toner particles. Following completion of the polymerization reaction, a slurry containing the above-mentioned particles was cooled, and after washing with an amount of water equal to 10 times the amount of slurry, filtering and drying, the particle diameter was adjusted by classification to obtain toner particles.

100 mass parts of the above-mentioned toner particles were mixed with 2.0 mass parts of hydrophobic silica fine particles [treated with a flowability improver in the form of dimethyl silicone oil (20 mass %), primary particle number average particle diameter: 10 nm, BET specific surface area: 170 m²/g, triboelectrically charged to the same polarity as the toner particles (negative polarity)], with a Henschel mixer (Mitsui Miike Machinery Co., Ltd.) for 15 minutes at 3000 r/min to obtain Toner (A).

<Toner Production Example 2>

A toner was produced in the same manner as Toner Production Example 1 by adding 44.4 mass parts of polystyrene resin having a peak molecular weight (Mp) of 3000 for the other resin in Toner Production Example 1 and adding other raw materials in accordance with the added amounts and types indicated in Table 2. The resulting toner was designated as Toner (B).

<Toner Production Example 3>

A toner was produced in the same manner as Toner Production Example 1 by adding 44.4 mass parts of polyester resin composed of (bisphenol A/propylene oxide) adduct and terephthalic acid (Mp=3500) for the other resin in Toner Production Example 2 and adding other raw materials in accordance with the added amounts and types indicated in Table 2. The resulting toner was designated as Toner (C).

<Toner Production Example 4>

A toner was produced in the same manner as Toner Production Example 1 in accordance with the added amounts and types indicated in Table 2 by changing to methyl methacrylate (MMA) instead of the n-butyl acrylate in Toner Production Example 1. The resulting toner was designated as Toner (D).

<Toner Production Example 5>

A toner was produced in the same manner as Toner Production Example 1 in accordance with the added amounts and types indicated in Table 2 by changing to acrylic acid (AA) instead of the n-butyl acrylate in Toner Production Example 1. The resulting toner was designated as Toner (E).

<Toner Production Example 6>

A toner was produced in the same manner as Toner Production Example 1 in accordance with the added amounts and types indicated in Table 2 by changing to methacrylic acid (MA) instead of the n-butyl acrylate in Toner Production Example 1. The resulting toner was designated as Toner (F).

<Toner Production Example 7>

A toner was produced in the same manner as Toner Production Example 1 in accordance with the added amounts and types indicated in Table 2 by changing the type of Resin A in Toner Production Example 1 to Resin (2). The resulting toner was designated as Toner (G).

<Toner Production Example 8>

A toner was produced in the same manner as Toner Production Example 1 in accordance with the added amounts and types indicated in Table 2 by changing the type of Resin A in Toner Production Example 1 to Resin (3). The resulting toner was designated as Toner (H).

<Toner Production Example 9>

A toner was produced in the same manner as Toner Production Example 1 in accordance with the added amounts and types indicated in Table 2 by changing the type of Resin A in Toner Production Example 1 to Resin (2). The resulting toner was designated as Toner (I).

<Toner Production Example 10>

A toner was produced in the same manner as Toner Production Example 1 in accordance with the added amounts and types indicated in Table 2 by changing the type of Resin A in Toner Production Example 1 to Resin (3). The resulting toner was designated as Toner (J).

<Toner Production Example 11>

A toner was produced in the same manner as Toner Production Example 1 with the exception of changing the added amount of polymerization initiator in the form of 2,2′-azobis(2,4-dimethylvaleronitrile) in Toner Production Example 1 to 25.0 mass parts. The resulting toner was designated as Toner (K).

<Toner Production Example 12>

A toner was produced in the same manner as Toner Production Example 1 with the exception of changing the added amount of polymerization initiator in the form of 2,2′-azobis(2,4-dimethylvaleronitrile) in Toner Production Example 1 to 1.0 mass part. The resulting toner was designated as Toner (L).

<Toner Production Example 13>

A toner was produced in the same manner as Toner Production Example 1 with the exception of changing to Resin (4) instead of Resin (1) in Toner Production Example 1. The resulting toner was designated as Toner (M).

<Toner Production Example 14>

A toner was produced in the same manner as Toner Production Example 1 with the exception of changing to Resin (5) instead of Resin (1) in Toner Production Example 1. The resulting toner was designated as Toner (N).

<Toner Production Example 15>

A toner was produced according to the dissolution suspension method in accordance with the procedure indicated below.

First, an aqueous medium and solution were prepared in accordance with the following procedure to prepare a toner.

660 mass parts of water and 25 mass parts of a 48.5 mass % aqueous sodium dodecyl diphenyl ether disulfonate solution were mixed and stirred followed by stirring using a TK Homomixer (Tokushu Kika Kogyo Co., Ltd.) at 10000 r/min to prepare a solution.

In addition, the following materials were added to 500 mass parts of ethyl acetate followed by dissolving with a propeller-type stirring apparatus at 100 r/min to prepare a solution.

| | | |
|---|---|---|
| Styrene-n-butyl acrylate copolymer | 100.0 | mass parts |
| (copolymer mass ratio: styrene/n-butyl | | |
| acrylate = 75/25, Mp = 17000) | | |
| Resin (1) | 3.8 | mass parts |
| C.I. Pigment Blue 15:3 | 6.5 | mass parts |
| Hydrocarbon wax (peak temperature of | 9.0 | mass parts |
| maximum endothermic peak: 77° C., | | |
| HNP-51, Nippon Seiro Co., Ltd.) | | |

Next, 150 mass parts of the aqueous medium were placed in a container followed by stirring at a rotating speed of 12000 rpm using a TK Homomixer (Tokushu Kika Kogyo Co., Ltd.), adding 100 mass parts of the above-mentioned solution, and mixing for 10 minutes to prepare an emulsified slurry.

Subsequently, 100 mass parts of the emulsified slurry were charged into a flask equipped with a degassing tube, stirrer and thermometer followed by removing the solvent under reduced pressure for 12 hours at 30° C. while stirring at a stirring peripheral velocity of 20 m/min and then aging for 4 hours at 45° C. to obtain a desolventized slurry. After filtering the desolventized slurry under reduced pressure, 300 mass parts of ion exchange water were added to the resulting filter cake followed by mixing with TK Homomixer, redispersing (for 10 minutes at a rotating speed of 12000 rpm) and filtering. The resulting filter cake was dried for 48 hours at 45° C. followed by sizing with a mesh sieve having a mesh size of 75 μm to obtain toner particles.

100 mass parts of the above-mentioned toner particles were mixed with 2.0 mass parts of hydrophobic silica fine particles [treated with a flowability improver in the form of dimethyl silicone oil (20 mass %), primary particle number average particle diameter: 10 nm, BET specific surface area: 170 m²/g, triboelectrically charged to the same polarity as the toner particles (negative polarity)], with a Henschel mixer (Mitsui Miike Machinery Co., Ltd.) for 15 minutes at 3000 r/min to obtain Toner (O).

<Toner Production Example 16>

A toner was produced according to the pulverization method in accordance with the procedure indicated below.

| | | |
|---|---|---|
| Styrene-n-butyl acrylate copolymer | 100.0 | mass parts |
| (copolymer mass ratio: styrene/n-butyl | | |
| acrylate = 75/25, Mp = 17000) | | |
| Resin (1) | 3.8 | mass parts |
| C.I. Pigment Blue 15:3 | 6.5 | mass parts |
| Hydrocarbon wax (peak temperature of | 9.0 | mass parts |
| maximum endothermic peak: 77° C., | | |
| HNP-51, Nippon Seiro Co., Ltd.) | | |

The above-mentioned materials were melted and kneaded followed by pulverizing to obtain toner particles.

100 mass parts of the above-mentioned toner particles were mixed with 2.0 mass parts of hydrophobic silica fine particles [treated with a flowability improver in the form of dimethyl silicone oil (20 mass %), primary particle number average particle diameter: 10 nm, BET specific surface area: 170 m²/g, triboelectrically charged to the same polarity as the toner particles (negative polarity), with a Henschel mixer (Mitsui Miike Machinery Co., Ltd.) for 15 minutes at 300 r/min to obtain Toner (P).

<Toner Production Examples 17 to 20>

Toners were produced in the same manner as Toner Production Example 1 in accordance with the added amounts and types used in Toner Production Example 1 as indicated in Table 2. The resulting toners were designated as Toners (Q), (R), (S) and (T).

<Comparative Toner Production Examples 1 to 8>

Toners were produced in the same manner as Toner Production Example 1 in accordance with the added amounts and types used in Toner Production Example 1 as indicated in Table 3. The resulting toners were designated as Toners (a), (b), (c), (d), (e), (f), (g) and (h).

<Comparative Toner Production Example 9>

A toner was produced in the same manner as Toner Production Example 1 in accordance with the added amounts and types indicated in Table 3 by adding 57.2 mass parts of polystyrene resin (Mp=5000) for the other resin in Toner Production Example 1. The resulting toner was designated as Toner (i).

<Comparative Toner Production Example 10>

A toner was produced in the same manner as Toner Production Example 1 in accordance with the added amounts and types indicated in Table 3 without adding the acrylic monomer used in Toner Production Example 1. The resulting toner was designated as Toner (j).

TABLE 2

| | Toner Production Example | | | | | | | | | | | | | | | | | |
|---|---|---|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 17 | 18 | 19 | 20 |
| Styrene | 75.0 | 41.7 | 41.7 | 75.0 | 75.0 | 75.0 | 75.0 | 75.0 | 54.0 | 54.0 | 75.0 | 75.0 | 75.0 | 75.0 | 50.3 | 50.3 | 75.0 | 75.0 |
| (mass parts) | | | | | | | | | | | | | | | | | | |
| Acrylic monomer | 25.0 | 13.9 | 13.9 | 25.0 | 25.0 | 25.0 | 25.0 | 25.0 | 18.0 | 18.0 | 25.0 | 25.0 | 25.0 | 25.0 | 16.8 | 16.8 | 25.0 | 25.0 |
| (mass parts) | | | | | | | | | | | | | | | | | | |
| Type of Resin A | (1) | (1) | (1) | (1) | (1) | (1) | (2) | (3) | (2) | (3) | (1) | (1) | (4) | (5) | (8) | (3) | (8) | (3) |
| Added amount of | 3.8 | 2.3 | 2.3 | 3.8 | 3.8 | 3.8 | 1.6 | 1.6 | 28.0 | 28.0 | 3.8 | 3.8 | 3.8 | 3.8 | 33.0 | 33.0 | 1.6 | 1.6 |
| Resin A | | | | | | | | | | | | | | | | | | |
| (mass parts) | | | | | | | | | | | | | | | | | | |
| Added amount of | 6.5 | 6.5 | 6.5 | 6.5 | 6.5 | 6.5 | 6.5 | 6.5 | 6.5 | 6.5 | 6.5 | 6.5 | 6.5 | 6.5 | 6.5 | 6.5 | 6.5 | 6.5 |
| C.I. pigment blue | | | | | | | | | | | | | | | | | | |
| 15:3 (mass parts) | | | | | | | | | | | | | | | | | | |
| Added amount of | 9.0 | 9.0 | 9.0 | 9.0 | 9.0 | 9.0 | 9.0 | 9.0 | 9.0 | 9.0 | 9.0 | 9.0 | 9.0 | 9.0 | 9.0 | 9.0 | 9.0 | 9.0 |
| hydrocarbon wax | | | | | | | | | | | | | | | | | | |
| (mass parts) | | | | | | | | | | | | | | | | | | |
| Other resin | — | 44.4 | 44.4 | — | — | — | — | — | — | — | — | — | — | — | — | — | — | — |
| (mass parts) | | | | | | | | | | | | | | | | | | |
| Polymerization | 10.0 | 10.0 | 10.0 | 10.0 | 10.0 | 10.0 | 10.0 | 10.0 | 10.0 | 10.0 | 25.0 | 1.0 | 10.0 | 10.0 | 10.0 | 10.0 | 10.0 | 10.0 |
| initiator | | | | | | | | | | | | | | | | | | |
| (mass parts) | | | | | | | | | | | | | | | | | | |
| Resin A content | 3.7 | 2.3 | 2.3 | 3.7 | 3.7 | 3.7 | 1.6 | 1.6 | 28.0 | 28.0 | 3.7 | 3.7 | 3.7 | 3.7 | 33.0 | 33.0 | 1.6 | 1.6 |
| ratio (mass %) | | | | | | | | | | | | | | | | | | |
| Styrene acrylic | 96.3 | 54.3 | 54.3 | 96.3 | 96.3 | 96.3 | 98.4 | 98.4 | 72.0 | 72.0 | 96.3 | 96.3 | 96.3 | 96.3 | 67.0 | 67.0 | 98.4 | 98.4 |
| resin content | | | | | | | | | | | | | | | | | | |
| ratio (mass %) | | | | | | | | | | | | | | | | | | |

TABLE 3

| | Comparative Toner | | | | | | | | | |
|---|---|---|---|---|---|---|---|---|---|---|
| | Production Example | | | | | | | | | |
| | 1 | 2 | 3 | 4 | 5 | 6 | 7 | 8 | 9 | 10 |
| Styrene | 47.1 | 50.3 | 75.0 | 75.0 | 75.0 | 75.0 | 50.3 | 44.1 | 32.1 | 100.0 |
| (mass parts) | | | | | | | | | | |
| Acrylic monomer | 15.7 | 16.8 | 25.0 | 25.0 | 25.0 | 25.0 | 16.8 | 14.7 | 10.7 | 0.0 |
| (mass parts) | | | | | | | | | | |
| Type of Resin A | (2) | (6) | (7) | (3) | (6) | (2) | (7) | (3) | (1) | (1) |
| Added amount of | 37.2 | 33.0 | 2.1 | 0.4 | 1.5 | 0.3 | 33.0 | 41.2 | 3.8 | 4.0 |
| Resin A | | | | | | | | | | |
| (mass parts) | | | | | | | | | | |
| Added amount of | 6.5 | 6.5 | 6.5 | 6.5 | 6.5 | 6.5 | 6.5 | 6.5 | 6.5 | 6.5 |
| C.I. pigment blue | | | | | | | | | | |
| 15:3 (mass parts) | | | | | | | | | | |
| Added amount of | 9.0 | 9.0 | 9.0 | 9.0 | 9.0 | 9.0 | 9.0 | 9.0 | 9.0 | 9.0 |
| hydrocarbon wax | | | | | | | | | | |
| (mass parts) | | | | | | | | | | |
| Other resin | — | — | — | — | — | — | — | — | 57.2 | — |
| (mass parts) | | | | | | | | | | |
| Polymerization | 10.0 | 10.0 | 10.0 | 10.0 | 10.0 | 10.0 | 10.0 | 10.0 | 10.0 | 10.0 |
| initiator | | | | | | | | | | |
| (mass parts) | | | | | | | | | | |
| Resin A content | 37.2 | 33.0 | 2.1 | 0.4 | 1.5 | 0.3 | 33.0 | 41.2 | 3.7 | 3.8 |
| ratio (mass %) | | | | | | | | | | |
| Styrene acrylic | 62.8 | 67.0 | 97.9 | 99.6 | 98.5 | 99.7 | 67.0 | 58.8 | 41.2 | 0.0 |
| resin content ratio | | | | | | | | | | |
| (mass %) | | | | | | | | | | |

The polyester resin A (type, content ratio) and styrene acrylic resin (type, content ratio, peak molecular weight) contained in the toners of Toners (A) to (T) and (a) to (j) are shown in Table 4.

TABLE 4

| | | Polyester resin A | | Styrene acrylic resin | | | |
|---|---|---|---|---|---|---|---|
| | | | Content | | Content | Peak | Toner |
| | | | ratio | | ratio | molecular | production |
| | Toner | Type | (mass %) | Type | (mass %) | weight | method |
| Toner | | | | | | | |
| Production | | | | | | | |
| Example | | | | | | | |
| 1 | (A) | (1) | 3.7 | St-BA | 96.3 | 17000 | *(1) |
| 2 | (B) | (1) | 2.3 | St-BA | 54.3 | 17100 | *(1) |
| 3 | (C) | (1) | 2.3 | St-BA | 54.3 | 17000 | *(1) |
| 4 | (D) | (1) | 3.7 | St-MMA | 96.3 | 17000 | *(1) |
| 5 | (E) | (1) | 3.7 | St-AA | 96.3 | 17000 | *(1) |
| 6 | (F) | (1) | 3.7 | St-MA | 96.3 | 17100 | *(1) |
| 7 | (G) | (2) | 1.6 | St-BA | 98.4 | 17300 | *(1) |
| 8 | (H) | (3) | 1.6 | St-BA | 98.4 | 16900 | *(1) |
| 9 | (I) | (2) | 28.0 | St-BA | 72.0 | 17100 | *(1) |
| 10 | (J) | (3) | 28.0 | St-BA | 72.0 | 17300 | *(1) |
| 11 | (K) | (1) | 3.7 | St-BA | 96.3 | 4000 | *(1) |
| 12 | (L) | (1) | 3.7 | St-BA | 96.3 | 230000 | *(1) |
| 13 | (M) | (4) | 3.7 | St-BA | 96.3 | 17000 | *(1) |
| 14 | (N) | (5) | 3.7 | St-BA | 96.3 | 17000 | *(1) |
| 15 | (O) | (1) | 3.7 | St-BA | 96.3 | 17000 | *(2) |
| 16 | (P) | (1) | 3.7 | St-BA | 96.3 | 17000 | *(3) |
| 17 | (Q) | (8) | 33.0 | St-BA | 67.0 | 17100 | *(1) |
| 18 | (R) | (3) | 33.0 | St-BA | 67.0 | 17100 | *(1) |
| 19 | (S) | (8) | 1.6 | St-BA | 98.4 | 17000 | *(1) |
| 20 | (T) | (3) | 1.6 | St-BA | 98.4 | 17100 | *(1) |
| Comparative | | | | | | | |
| Toner | | | | | | | |
| Production | | | | | | | |
| Example | | | | | | | |
| 1 | (a) | (2) | 37.2 | St-BA | 62.8 | 17100 | *(1) |
| 2 | (b) | (6) | 33.0 | St-BA | 67.0 | 16800 | *(1) |
| 3 | (c) | (7) | 2.1 | St-BA | 97.9 | 17400 | *(1) |
| 4 | (d) | (3) | 0.4 | St-BA | 99.6 | 17100 | *(1) |
| 5 | (e) | (6) | 1.5 | St-BA | 98.5 | 17300 | *(1) |
| 6 | (f) | (2) | 0.3 | St-BA | 99.7 | 17100 | *(1) |
| 7 | (g) | (7) | 33.0 | St-BA | 67.0 | 17000 | *(1) |
| 8 | (h) | (3) | 41.2 | St-BA | 58.8 | 16800 | *(1) |
| 9 | (i) | (1) | 3.7 | St-BA | 41.2 | 16900 | *(1) |

| | | | | | |
|---|---|---|---|---|---|
| 10 | (j) | (1) | 3.8 | Not added | *(1) |

*(1) Suspension polymerization method
*(2) Dissolution suspension method
*(3) Pulverization method

<Examples 1 to 20 and Comparative Examples 1 to 10>

Toners (A) to (T) and Toners (a) to (j) were respectively evaluated for image density and fogging in three environments. The results are shown in Table 5. Furthermore, LL, NN and HH in the table respectively indicate low temperature and low humidity (temperature: 10° C., humidity: 15% RH), normal temperature and normal humidity (temperature: 23° C., humidity: 60% RH) and high temperature and high humidity (temperature: 30° C., humidity: 85% RH). In addition, the numerical values indicated in the table indicate the value for the 1st and 5000th printouts.

<Evaluation Methods>

70 g of toner were filled into a developer container in the developing assembly (Satera LBP5300, Canon, Inc.) of a single component development system shown in FIG. 1. Furthermore, Xerox 4200 (Xerox Corp., 75 g/m² paper) was used for the transfer paper. The developing assembly shown in FIG. 1 was installed in the unit 104a shown in FIG. 2 in each of the three environments indicated below:

low temperature, low humidity (temperature:
10° C., humidity: 15% RH)
normal temperature, normal humidity (temperature:
23° C., humidity: 60% RH)
high temperature, high humidity (temperature:
30° C., humidity: 85% RH).

Printing was carried out in the cyan monochromatic mode at a process speed of 150 mm/s. Solid images (image coverage rate: 4%) were printed continuously so that the toner amount laid on the transfer paper was 0.40 mg/cm², and images on the 1st and 5000th printouts were evaluated for image density and fogging.

<Measurement and Evaluation of Image Density>

Image density was evaluated according to the image density of solid images. Furthermore, image density was determined by measuring relative density with respect to an image printed out on a white background having a original density of 0.00 using the Macbeth Reflection Densitometer Model RD918 (Gretag Macbeth GmbH).

(Evaluation Criteria)

A: 1.40 or more

B: 1.30 or more to less than 1.40

C: 1.20 or more to less than 1.30

D: 1.15 or more to less than 1.20

E: 1.10 or more to less than 1.15

F: Less than 1.10

An image density of E or lower was judged to indicate that the effects of the present invention are inadequate.

<Measurement and Evaluation of Fogging>

Reflectance (%) was measured on a non-image portion of an image printed out with the Model TC-6DS Reflectometer (Tokyo Denshoku Co., Ltd.). The value (%) obtained by subtracting the resulting reflectance from the reflectance (%) of an unused paper (standard paper) measured in the same manner was used to evaluate fogging. A lower value for the resulting value indicates greater inhibition of image fogging.

(Evaluation Criteria)

A: Less than 0.10%

B: 0.10% or more to less than 1.00%

C: 1.00% or more to less than 2.50%

D: 2.50% or more to less than 4.00%

E: 4.00% or more

Image fogging of D or higher was judged to indicate that the effects of the present invention are inadequate.

TABLE 5

| | | Image Density | | | Fogging | | |
|---|---|---|---|---|---|---|---|
| | Toner | LL | NN | HH | LL | NN | HH |
| Example 1 | (A) | 1.45/1.42 | 1.48/1.45 | 1.48/1.48 | 0.01/0.02 | 0.00/0.01 | 0.01/0.05 |
| | | A/A | A/A | A/A | A/A | A/A | A/A |
| Example 2 | (B) | 1.44/1.42 | 1.48/1.45 | 1.46/1.45 | 0.02/0.03 | 0.02/0.03 | 0.02/0.06 |
| | | A/A | A/A | A/A | A/A | A/A | A/A |
| Example 3 | (C) | 1.47/1.41 | 1.44/1.42 | 1.38/1.36 | 0.01/0.02 | 0.02/0.03 | 0.06/0.09 |
| | | A/A | A/A | B/B | A/A | A/A | A/A |
| Example 4 | (D) | 1.47/1.40 | 1.44/1.41 | 1.37/1.35 | 0.01/0.03 | 0.02/0.04 | 0.07/0.16 |
| | | A/A | A/A | B/B | A/A | A/A | A/B |
| Example 5 | (E) | 1.45/1.40 | 1.42/1.39 | 1.35/1.32 | 0.01/0.05 | 0.02/0.05 | 0.07/0.21 |
| | | A/A | A/B | B/B | A/A | A/A | A/B |
| Example 6 | (F) | 1.42/1.40 | 1.40/1.35 | 1.35/1.30 | 0.03/0.07 | 0.04/0.06 | 0.11/0.29 |
| | | A/A | A/B | B/B | A/A | A/A | B/B |
| Example 7 | (G) | 1.47/1.36 | 1.44/1.40 | 1.38/1.32 | 0.20/0.29 | 0.02/0.05 | 0.06/0.11 |
| | | A/B | A/A | B/B | B/B | A/A | A/B |
| Example 8 | (H) | 1.45/1.42 | 1.48/1.45 | 1.48/1.48 | 0.01/0.02 | 0.00/0.01 | 0.01/0.05 |
| | | A/A | A/A | A/A | A/A | A/A | A/A |
| Example 9 | (I) | 1.43/1.42 | 1.41/1.40 | 1.36/1.35 | 0.04/0.05 | 0.10/0.16 | 0.30/0.39 |
| | | A/A | A/A | B/B | A/A | B/B | B/B |
| Example 10 | (J) | 1.40/1.39 | 1.41/1.39 | 1.34/1.32 | 0.04/0.05 | 0.10/0.33 | 0.46/0.75 |
| | | A/B | A/B | B/B | A/A | B/B | B/B |
| Example 11 | (K) | 1.39/1.38 | 1.40/1.38 | 1.33/1.31 | 0.06/0.06 | 0.07/0.09 | 0.88/1.25 |
| | | B/B | A/B | B/B | A/A | A/A | B/C |
| Example 12 | (L) | 1.40/1.39 | 1.40/1.39 | 1.38/1.36 | 0.08/0.10 | 0.09/0.11 | 0.09/1.15 |
| | | A/B | A/B | B/B | A/B | A/B | A/C |
| Example 13 | (M) | 1.35/1.32 | 1.34/1.32 | 1.29/1.28 | 0.09/1.12 | 0.09/1.21 | 0.10/1.26 |
| | | B/B | B/B | C/C | A/C | A/C | B/C |
| Example 14 | (N) | 1.35/1.31 | 1.32/1.30 | 1.29/1.27 | 0.09/1.15 | 0.10/1.23 | 0.12/1.29 |
| | | B/B | B/B | C/C | A/C | B/C | B/C |
| Example 15 | (O) | 1.33/1.30 | 1.30/1.25 | 1.28/1.25 | 0.56/1.26 | 0.33/1.55 | 0.30/1.45 |
| | | B/B | B/C | C/C | B/C | B/C | B/C |
| Example 16 | (P) | 1.28/1.20 | 1.26/1.18 | 1.20/1.15 | 0.80/1.90 | 0.79/1.96 | 1.23/2.45 |
| | | C/C | C/D | C/D | B/C | B/C | B/C |
| Example 17 | (Q) | 1.43/1.42 | 1.41/1.40 | 1.30/1.25 | 0.08/0.09 | 0.11/0.18 | 0.35/0.46 |
| | | A/A | A/A | B/C | A/A | B/B | B/B |
| Example 18 | (R) | 1.40/1.39 | 1.40/1.37 | 1.33/1.29 | 0.04/0.05 | 0.10/0.33 | 0.46/0.75 |
| | | A/B | A/B | B/C | A/A | B/B | B/B |
| Example 19 | (S) | 1.43/1.42 | 1.41/1.40 | 1.30/1.29 | 0.35/0.41 | 0.02/0.10 | 0.06/0.15 |
| | | A/A | A/A | B/C | B/B | A/B | A/B |
| Example 20 | (T) | 1.44/1.41 | 1.40/1.38 | 1.44/1.42 | 0.05/0.10 | 0.00/0.05 | 0.03/0.11 |
| | | A/A | A/B | A/A | A/B | A/A | A/B |
| Comparative | (a) | 1.28/1.21 | 1.24/1.15 | 1.15/1.14 | 0.82/0.89 | 0.92/0.95 | 1.88/3.12 |
| Example 1 | | C/C | C/D | D/E | B/B | B/B | C/D |
| Comparative | (b) | 1.26/1.24 | 1.24/1.15 | 1.12/1.11 | 1.23/1.45 | 0.99/1.23 | 0.89/1.22 |
| Example 2 | | C/C | C/D | E/E | C/C | B/C | B/C |
| Comparative | (c) | 1.25/1.22 | 1.22/1.13 | 1.10/1.08 | 2.12/2.56 | 2.23/2.66 | 3.23/4.12 |
| Example 3 | | C/C | C/E | E/F | C/D | C/D | D/E |
| Comparative | (d) | 1.40/1.18 | 1.40/1.13 | 1.43/1.08 | 0.04/2.33 | 0.03/2.66 | 0.03/3.48 |
| Example 4 | | A/D | A/E | A/F | A/C | A/D | A/D |
| Comparative | (e) | 1.40/1.18 | 1.41/1.12 | 1.43/1.10 | 0.03/2.25 | 0.03/2.54 | 0.03/3.51 |
| Example 5 | | A/D | A/E | A/E | A/C | A/D | A/D |
| Comparative | (f) | 1.42/1.20 | 1.40/1.11 | 1.43/1.05 | 0.04/2.29 | 0.04/2.68 | 0.05/3.49 |
| Example 6 | | A/C | A/E | A/F | A/C | A/D | A/D |
| Comparative | (g) | 1.12/1.10 | 1.13/1.07 | 1.05/0.95 | 2.88/2.96 | 3.22/3.56 | 3.88/4.56 |
| Example 7 | | E/E | E/F | F/F | D/D | D/D | D/E |
| Comparative | (h) | 1.11/1.09 | 1.10/1.06 | 1.04/0.91 | 2.96/3.11 | 3.32/3.59 | 3.90/4.59 |
| Example 8 | | E/F | E/F | F/F | D/D | D/D | D/E |
| Comparative | (i) | 1.09/1.01 | 1.08/0.96 | 0.96/0.88 | 3.12/3.23 | 3.53/3.69 | 4.10/4.88 |
| Example 9 | | F/F | F/F | F/F | D/D | D/D | E/E |
| Comparative | (j) | 0.99/0.96 | 0.96/0.93 | 0.88/0.78 | 4.12/4.59 | 4.33/4.56 | 5.63/6.58 |
| Example 10 | | F/F | F/F | F/F | E/E | E/E | E/E |

In FIG. 1, reference symbol 10 indicates a latent image bearing member (photosensitive drum), 11 a contact charging member, 12 a power supply, 13 a developing unit, 14 a toner carrying member, 15 a toner supply roller, 15a a toner supply roller shaft, 16 a regulating member, 17 a non-magnetic toner, 23 a developer container, 24 a regulating member supporting metal sheet, 25 a toner stirring member, 26 a toner blowout preventive sheet, 27 a power supply, 29 a charging roller, and 30 a suppressing member. Reference symbol B, C, and D indicate rotation directions.

In FIG. 2, reference symbols 101a to 101d indicate photosensitive drums, 102a to 102d primary charging means, 103a to 103d scanners, 104a to 104d developing units, 106a to 106d cleaning means, 108b a paper feeding roller, 108c a registration roller, 109a an electrostatically attracting transport belt, 109b a driver roller, 109c a stationary roller, 109d a tension roller, 109e a stationary roller, 110 fixing unit, 110c a discharge roller, 110d a destaticizing sheet, 111 a fixing unit frame body, 111a a paper guide, 112 fixing unit maintenance port, 112a a fixing unit immobilizing member, 113 a discharge tray, 115 and 116 discharge rollers, 117 a paper guide and S a recording medium.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-038036, filed Feb. 28, 2014 which is hereby incorporated by reference herein in its entirety.

What is claimed is:

1. A toner comprising
a toner particle containing a resin,
wherein
the resin contains a styrene acrylic resin and a polyester resin A,
a content ratio of the styrene acrylic resin is from at least 50.0 mass % to not more than 99.0 mass % based on the resin,
a content ratio of the polyester resin A is from at least 1.0 mass % to not more than 35.0 mass % based on the resin, and
the polyester resin A contains an isosorbide unit represented by the following formula (1), the unit being contained in a molar ratio of from at least 0.10 mol % to not more than 30.0 mol % based on a total number of monomer units constituting the polyester resin A.

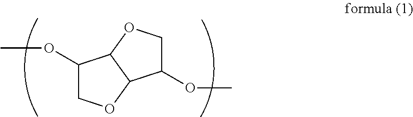

2. The toner according to claim 1,
wherein an acid value of the polyester resin A is from at least 0.5 mgKOH/g to not more than 25.0 mgKOH/g.

3. The toner according to claim 1,
wherein a peak molecular weight (Mp) of the styrene acrylic resin is from at least 5000 to not more than 30000.

4. The toner according to claim 1,
wherein the toner particle is produced by
dispersing, in an aqueous medium, a polymerizable monomer composition containing a polymerizable monomer that forms the styrene acrylic resin, and the polyester resin A to form a particle of the polymerizable monomer composition, and
polymerizing the polymerizable monomer contained in the particle.
